(19) United States
(12) Patent Application Publication
(10) Pub. No.: US 2026/0106170 A1
(43) Pub. Date: Apr. 16, 2026

(54) ELECTRODE, ELECTRODE ASSEMBLY INCLUDING SAME AND METHOD FOR MANUFACTURING ELECTRODE

(71) Applicant: SAMSUNG SDI CO., LTD., Yongin-si (KR)

(72) Inventors: Jungah YOON, Yongin-si (KR); Taesu JEONG, Yongin-si (KR)

(21) Appl. No.: 19/337,026

(22) Filed: Sep. 23, 2025

(30) Foreign Application Priority Data
Oct. 16, 2024 (KR) 10-2024-0140847

(51) Int. Cl. H01M 4/66; H01M 4/82; H01M 50/534; H01M 50/536; H01M 50/586

(52) U.S. Cl. CPC H01M 4/667; H01M 4/661; H01M 4/82; H01M 50/534; H01M 50/536; H01M 50/586

(57) ABSTRACT

An electrode including a multilayer substrate including a polymer layer between a first metal layer and a second metal layer, a substrate tab including a welded portion, the welded portion being welded to a surface of at least one of the first metal layer and the second metal layer, an active material layer on the surface of at least one of the first metal layer and the second metal layer, the active material layer including an active material, and an insulating layer covering at least a portion of the welded portion.

### CROSS-REFERENCE TO RELATED APPLICATION

This application claims priority under 35 U.S.C. § 119 to Korean Patent Application No. 10-2024-0140847, filed in the Korean Intellectual Property Office on Oct. 16, 2024, the entire contents of which are hereby incorporated by reference.

### BACKGROUND

### 1. Field

The present disclosure relates to an electrode, an electrode assembly including the same, and a method for manufacturing an electrode.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In line with the advancement of digital convergence, electronic devices and/or automobiles are providing various functions and/or various services integrated therewith. Accordingly, technologies are being proposed to improve the performance of secondary batteries, which are the central foundation for the operation of electronic devices and/or automobiles. For example, a multilayer substrate in which the metal substrate of the electrode included in the secondary battery is composed of an insulating substrate and metal substrates on both sides thereof may be implemented, so replacing a part of a whole metal substrate with an insulating substrate in the multilayer substrate may contribute to a weight reduction of the secondary battery.

In a multilayer substrate, an electrical connection between metal substrates having the insulating substrate therebetween may not be possible due to the insulating properties of the insulating substrate. Accordingly, the metal substrates in the multilayer substrate may be welded to separate substrate tabs, and may be electrically connected to the outside through the separate substrate tabs.

The above information disclosed in this Background section is for enhancement of understanding of the background of the present disclosure, and therefore, it may contain information that does not constitute related (or prior) art.

### SUMMARY

According to an embodiment of the present disclosure, an electrode includes a multilayer substrate including a metal layer including a first metal layer and a second metal layer facing each other, and a polymer layer disposed between the first metal layer and the second metal layer; a substrate tab including a welded portion welded to a surface of the metal layer; an active material layer in which an active material is applied to the surface of the metal layer; and an insulating layer disposed to cover at least a portion of a surface of the welded portion.

According to an embodiment, a material of the polymer layer may include polyethylene terephthalate (PET).

According to an embodiment, a material of the first metal layer and a material of the second metal layer may include either aluminum (Al) or copper (Cu).

According to an embodiment, a thickness of each of the first metal layer and the second metal layer may be smaller than a thickness of the polymer layer.

According to an embodiment, a material of the substrate tab may include either aluminum (Al) or copper (Cu).

According to an embodiment, a material of the insulating layer may include either polyimide (PI) or ceramic.

According to an embodiment, the active material layer may be disposed to be in contact with the welded portion, and the insulating layer may be disposed to be in contact with the active material layer.

According to an embodiment, a thickness of the substrate tab may be greater than or equal to a thickness of a multilayer substrate.

According to an embodiment, a thickness of the insulating layer may be greater than the thickness of the substrate tab.

According to an embodiment, a width of the insulation layer may be equal to a width of the welded portion.

According to an embodiment, the multilayer substrate may include a non-coated portion where a surface of the metal layer is exposed, the welded portion may be formed at a position spaced apart from a boundary line between the active material layer and the non-coated portion by a certain distance, and the insulating layer is disposed to cover at least a portion of the surface of the non-coated portion and the surface of the welded portion.

According to an embodiment, a width of a portion of the insulating layer disposed on the surface of the non-coated portion may be the same as a width of the non-coated portion, and a width of a portion of the insulating layer disposed on the surface of the welded portion may be 10% to 99% of the width of the welded portion.

According to an embodiment, a thickness of a portion of the insulating layer disposed on the surface of the non-coated portion may be greater than a thickness of a portion of the insulating layer disposed on the surface of the welded portion.

According to an embodiment of the present disclosure, an electrode assembly includes a first electrode including a first substrate tab connected to a first lead tab; a second electrode including a second substrate tab connected to a second lead tab; and a separator that is interposed between the first electrode and the second electrode, in which the first electrode includes a multilayer substrate including a metal layer including a first metal layer and a second metal layer facing each other, and a polymer layer disposed between the first metal layer and the second metal layer, and an active material layer in which an active material is applied to a surface of the metal layer, and the first substrate tab includes a welded portion welded to the surface of the metal layer, and an insulating layer disposed to cover at least a portion of a surface of the welded portion.

According to an embodiment, the active material layer may be disposed to be in contact with the welded portion, and the insulating layer may be disposed to be in contact with the active material layer.

According to an embodiment, a width of the insulation layer may be equal to a width of the welded portion.

According to an embodiment, the first substrate tab and the second substrate tab may protrude from the separator.

According to an embodiment of the present disclosure, a method for manufacturing an electrode includes a step of preparing a multilayer substrate including a metal layer including a first metal layer and a second metal layer facing each other, and a polymer layer disposed between the first metal layer and the second metal layer; a step of welding a substrate tab to a surface of the metal layer; a step of simultaneously applying an active material to the surface of the metal layer and an insulating material to at least a part of a surface of a welded portion; and a step of cutting the multilayer substrate.

According to an embodiment, the step of welding the substrate tab to the surface of the metal layer may include a step of ultrasonically welding one end of the metal layer such that the substrate tab protrudes from the metal layer.

According to an embodiment, the step of simultaneously applying an active material to the surface of the metal layer and an insulating material to at least a part of a surface of a welded portion may include a step of applying the active material to be in contact with the welded portion and completely cover the surface of the metal layer, and a step of applying the insulating material to be in contact with the active material and completely cover the surface of the welded portion.

According to an embodiment, the step of cutting the multilayer substrate may include a step of cutting the multilayer substrate parallel to a length direction of the multilayer substrate.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a plan view showing an example of an electrode assembly according to an embodiment of the present disclosure.

FIG. 2 is a side view showing an example of an electrode assembly according to an embodiment of the present disclosure.

FIG. 3 is a side view showing an example of an electrode assembly with a bent substrate tab according to an embodiment of the present disclosure.

FIG. 4 is a cross-sectional view showing an example of a multilayer substrate according to an embodiment of the present disclosure.

FIG. 5 is a plan view showing an example of a multilayer substrate combined with substrate tabs according to an embodiment of the present disclosure.

FIG. 6 is a plan view showing an example of a multilayer substrate having an active material layer disposed to be in contact with a welded portion according to an embodiment of the present disclosure.

FIG. 7 is a cross-sectional view showing an example of a multilayer substrate in which an active material layer and an insulating layer are disposed, according to an embodiment of the present disclosure.

FIG. 8 is a plan view showing an example of a punched electrode according to an embodiment of the present disclosure.

FIG. 9 is a plan view showing an example of a multilayer substrate in which an active material layer is disposed to be spaced apart from a welded portion according to an embodiment of the present disclosure.

FIG. 10 is a cross-sectional view showing an example of a multilayer substrate in which an active material layer and an insulating layer are disposed, according to an embodiment of the present disclosure.

FIG. 11 is a plan view showing an example of a multilayer substrate having an active material layer disposed to be spaced apart from a welded portion, according to an embodiment of the present disclosure.

FIG. 12 is a cross-sectional view showing an example of a multilayer substrate in which an active material layer and an insulating layer are disposed, according to an embodiment of the present disclosure.

FIG. 13 is a flow chart of a method for manufacturing an electrode according to an embodiment of the present disclosure.

FIG. 14 is a diagram of stages in a method for manufacturing an electrode according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In this disclosure, the sizes and relative sizes of layers and regions shown in the drawings may be exaggerated for clarity of explanation. In addition, identical reference numerals throughout the specification refer to same components.

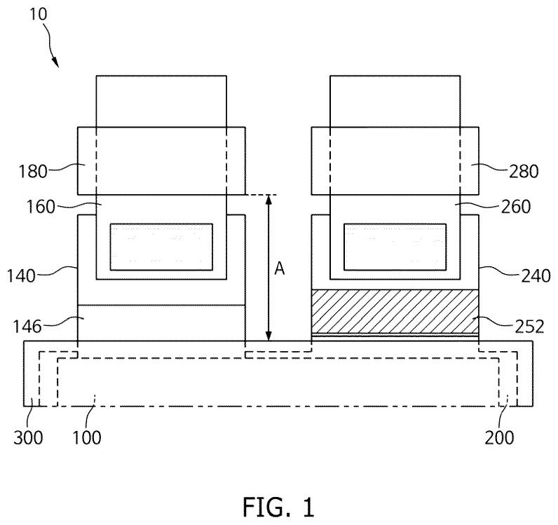

FIG. 1 is a plan view showing an example of an electrode assembly according to an embodiment of the present disclosure. It is noted that FIG. 1 illustrates a top of an electrode assembly, with substrate tabs protruding from the top of the electrode assembly.

Referring to FIG. 1, an electrode assembly 10 may include a first electrode 100, a separator 300, and a second electrode 200 formed in a thin plate shape or film shape. For example, as illustrated in FIG. 1, the electrode assembly 10 may be formed in a structure in which the first electrode 100 and the second electrode 200 made of a plurality of sheets are alternately stacked with the separator 300 therebetween. In another example, the electrode assembly 10 may be formed by winding the first electrode 100, the second electrode 200, and the separator 300 interposed between the first electrode 100 and the second electrode 200.

The separator 300 may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator 300 may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

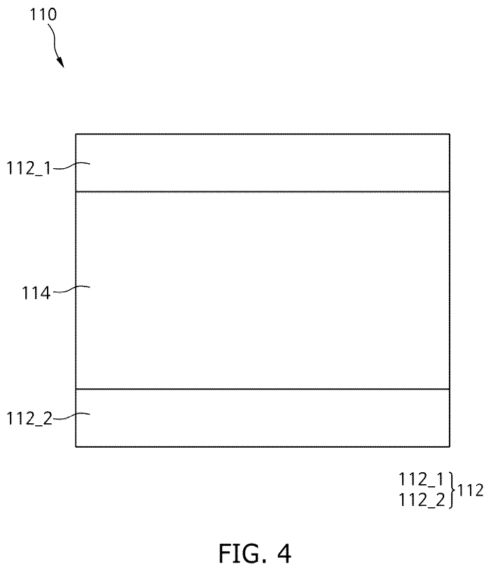

According to an embodiment, the first electrode 100 and the second electrode 200 may include a multilayer substrate and an active material layer disposed on a surface of the multilayer substrate. The multilayer substrate may include a metal layer including a first metal layer and a second metal layer facing each other, and a polymer layer disposed between the first metal layer and the second metal layer. The first electrode 100 may be formed as a positive electrode, and the second electrode 200 may be formed as a negative electrode, or vice versa. This will be described in more detail later with reference to FIG. 4.

To prevent physical short circuit between the first electrode 100 and the second electrode 200, the sizes of the first electrode 100 and the second electrode 200 may be different from each other. According to an embodiment, when the first electrode 100 is formed as a positive electrode and the second electrode 200 is formed as a negative electrode, the size (e.g., a length and/or a width) of the first electrode 100 may be smaller than the size of the second electrode 200. Additionally, the sizes of the first electrode 100 and the second electrode 200 may be smaller than the size of the separator 300.

According to an embodiment, the first electrode 100 may include a first substrate tab 140 on one side of the first electrode 100, and the second electrode 200 may include a second substrate tab 240 on one side of the second electrode 200. The first substrate tab 140 and the second substrate tab 240 may be formed by welding the substrate tabs to the non-coated portions of the first electrode 100 and the second electrode 200, respectively, and may be formed by punching out the non-coated portions of the first electrode 100 and the second electrode 200. In a stacked state, the first substrate tab 140 and the second substrate tab 240 may be disposed in parallel with a set interval therebetween.

When the first electrode 100 is formed as a positive electrode, the first substrate tab 140 may be formed as a positive tab, and the second substrate tab 240 may be formed as a negative tab. In other embodiments, when the polarities of the first electrode 100 and the second electrode 200 are reversed, the first substrate tab 140 may be formed as a negative tab, and the second substrate tab 240 may be formed as a positive tab.

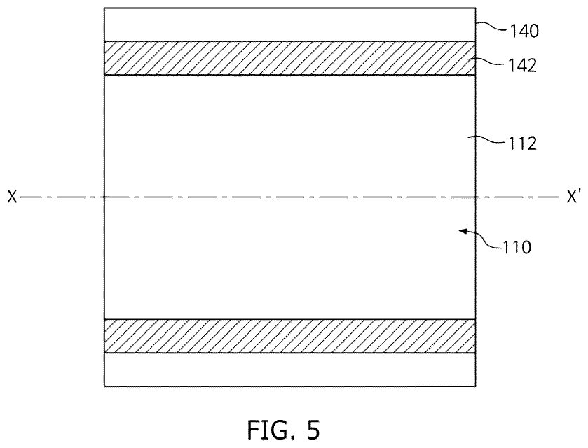

According to an embodiment, the first substrate tab 140 may include a welded portion welded to a surface of a metal layer of a multilayer substrate and an insulating layer 146 disposed to cover at least a portion of the surface of the welded portion. Specifically, the welded portion may be in contact with the active material layer disposed on the surface of the multilayer substrate. The insulating layer 146 may be disposed on the welded portion to be in contact with the active material layer disposed on the surface of the multilayer substrate. The width of the insulating layer 146 may be equal to the width of the welded portion. This will be described in detail later with reference to FIGS. 5 to 8.

According to an embodiment, the end of the separator 300 may be disposed on the plane of the insulating layer 146 (e.g., the end of the separator 300 may overlap the insulating layer 146 in a top view, as illustrated in FIG. 1). By arranging the insulating layer 146 on the first substrate tab 140 and/or the surface of the multilayer substrate, the possibility of a physical short circuit between the positive and negative electrodes due to deformation of the secondary battery or shrinkage of the separator 300 in a high-temperature atmosphere may be reduced. This may improve the safety and reliability of the secondary battery performance.

According to an embodiment, the second substrate tab 240 may include a welded portion 252 welded to the surface of the metal layer of the multilayer substrate. The welded portion 252 may protrude from the separator 300.

According to an embodiment, the first substrate tab 140 and the second substrate tab 240 may be coupled with the first lead tab 160 and the second lead tab 260, respectively, such that the electrode assembly 10 is electrically connected to the outside. The first and second substrate tabs 140 and 240, as well as the first and second lead tabs 160 and 260, may be formed of a metal, e.g., aluminum (Al), copper (Cu) or nickel (Ni), and may be formed of a metal having a certain level of electrical conductivity to minimize voltage drop.

According to an embodiment, the first and second lead tabs 160 and 260 may be formed by including first and second insulating films 180 and 280 positioned on one or both of the upper and lower surfaces, respectively. Specifically, the first and second lead tabs 160 and 260 may be formed by including the first and second insulating films 180 and 280 attached to a portion that comes into contact with the sealing portion of the edge of the case, respectively.

The bending length A of the electrode assembly 10 may refer to the length from the separator 300 (e.g., an edge of the separator 300 facing the substrate tabs) to the first and second insulating films 180 and 280 (e.g., edges of the first and second insulating films 180 and 280 facing the separator 300), with the first lead tab 160 in an bent state. Specifically, the bending length A of the electrode assembly 10 may refer to the length from the separator 300 to the end of the first and second insulating films 180 and 280 closest to the separator 300. The degree of thinning of the secondary battery may be set depending on the bending length A of the electrode assembly 10. In some forms of secondary batteries, the bending length A of the electrode assembly 10 may be reduced to make it thinner. This may improve the energy density of secondary batteries. In secondary batteries, energy density may mean the amount of energy that may be stored per unit volume.

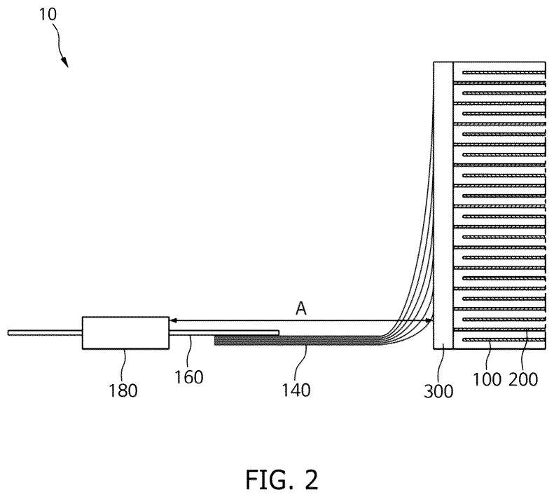

FIG. 2 is a side view of the electrode assembly 10 according to an embodiment of the present disclosure.

Referring to FIG. 2, the electrode assembly 10 may include a stack having the first electrode 100, the separator 300, and the second electrode 200 formed in a thin plate shape or film shape. The stack may be formed by winding or stacking the electrodes and the separator 300. When the electrode assembly 10 has a wound stack, the winding axis may be parallel to the longitudinal direction of the case. In other embodiments, the electrode assembly 10 may be a stack type rather than a winding type, and the shape of the electrode assembly 10 is not limited in the present disclosure. In addition, the electrode assembly 10 may be a Z-stack electrode assembly in which a positive electrode plate and a negative electrode plate are inserted into both sides of a separator 300, which is then bent into a Z-stack. In addition, one or more electrode assemblies 10 may be stacked such that long sides of the electrode assemblies are adjacent to each other and accommodated in the case, and the number of electrode assemblies in the case is not limited in the present disclosure. The first electrode 100 of the electrode assembly 10 may act as a negative electrode, and the second electrode 200 may act as a positive electrode. Of course, the reverse is also possible.

The first electrode 100 may include the first substrate tab 140 (e.g., a first non-coated portion). The first substrate tab 140 may be a current flow path between the first electrode 100 and the first lead tab 160. In some examples, the first substrate tab 140 may be formed by cutting it in advance to protrude to one side when manufacturing the first electrode 100, and may protrude further to one side than the separator 300 without separate cutting.

The second electrode 200 may include a second substrate tab (e.g., a second non-coated portion). The second substrate tab may be a current flow path between the second electrode and the second lead tab. In some examples, the second substrate tab may be formed by cutting it in advance to protrude to one side when manufacturing the second electrode, and may protrude further to one side than the separator 300 without separate cutting.

In some embodiments, the first electrode tab may be located on the left side of the electrode assembly, and the second electrode tab may be located on the right side of the electrode assembly. In other embodiments, the first electrode tab and the second electrode tab may be located on one side of the electrode assembly in the same direction. Here, for convenience of description, the left and right sides are defined according to the secondary battery as oriented in FIG. 2, and the positions thereof may change when the secondary battery is rotated left and right or up and down.

Because the first electrode 100 including the first substrate tab 140 includes the insulating layer 146 (see FIG. 1), the bending length A of the first electrode 100 may be affected (e.g., compared to the second electrode 200 in FIG. 1). Therefore, the following description will be based on the first electrode 100, but the second electrode 200 may also be described in the same way as the first electrode 100.

According to an embodiment, the bending length A of the electrode assembly 10 may include a portion of the length of the first substrate tab 140 protruding from the separator 300 and the length of the first lead tab 160. Accordingly, the bending length A of the electrode assembly 10 may be set according to the length of the first substrate tab 140 protruding from the separator 300.

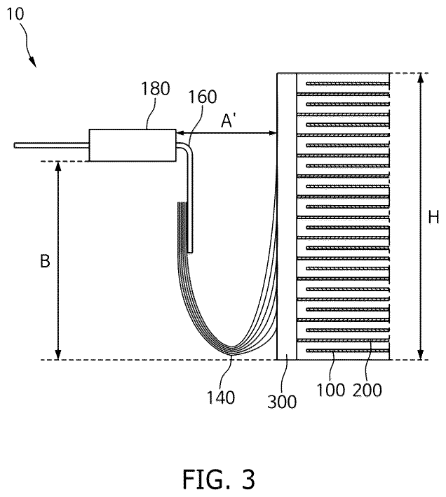

FIG. 3 is a side view of the electrode assembly 10 with a bent substrate tab according to an embodiment of the present disclosure.

Referring to FIG. 3, in the electrode assembly 10, the first substrate tab 140 and the first lead tab 160 may be bent. For example, the first substrate tab 140 may be bent upward at the setting portion, and the first lead tab 160 may be bent such that the first insulating film 180 is parallel to the upper/lower ends of the electrode assembly 10. For example, referring to FIG. 3, the first insulating film 180 may be positioned closer to the separator 300 (i.e., at a length A′ smaller than A), so the first substrate tab 140 and the first lead tab 160 may be bent between the first insulating film 180 and the electrode assembly 10. For example, referring to FIG. 3, the first lead tab 160 may be bent downward from the first insulating film 180 (e.g., perpendicularly with respect to the first insulating film 180), and the first substrate tab 140 may be bent (e.g., in a U-shape) between the first lead tab 160 and the separator 300.

The bending ratio may be used as a measure of the degree to which the bending length A′ of the electrode assembly 10 is bent. The bending ratio may refer to a value obtained by dividing the bending length A of the electrode assembly 10 illustrated in FIG. 2 by the thickness H of the electrode assembly 10 and then multiplying by 100. The bending length A of the electrode assembly 10 shown in FIG. 2 may be similar to the distance B from the lower end of the electrode assembly 10 shown in FIG. 3 to the lower end of the first insulating film 180. The distance B from the lower end of the electrode assembly 10 to the lower end of the first insulating film 180 may be referred to as a bending amount.

$$Bending ratio = \frac{B e nding length ( A ) of electrode assembly ( \approx Bending amount ( B )}{T h ickness ( H ) of electrode assembly} \times 100$$

The bending ratio may be set according to the type of secondary battery, and the optimal bending ratio for uniform bending shape may be about 85%. According to an embodiment, the bending ratio of the electrode assembly 10 may be about 85%, which is an optimal bending ratio. This prevents deformation of the plate and deformation of the substrate tab due to bending. In some embodiments, because the first lead tab 160 and the first insulating film 180 are positioned lower than the upper end of the electrode assembly 10 (with respect to the orientation of FIG. 3), a decrease in energy density that occurs due to the remaining upper space of the secondary battery may be prevented.

The bending ratio may be set according to the length of the first substrate tab 140 protruding from the separator 300. The bending ratio may be set to an optimal bending ratio by reducing the length of the first substrate tab 140 protruding from the separator 300. Due to this, the secondary battery may be made thinner, which may improve the energy density of the secondary battery.

FIG. 4 is a cross-sectional view showing an example of a multilayer substrate according to an embodiment of the present disclosure, and FIG. 5 is a plan view showing an example of a multilayer substrate combined with substrate tabs according to an embodiment of the present disclosure.

Referring to FIG. 4, a multilayer substrate 110 may include a metal layer 112 including a first metal layer 112_1 and a second metal layer 112_2 facing each other, and a polymer layer 114 disposed between the first metal layer 112_1 and the second metal layer 112_2.

According to an embodiment, each of the first metal layer 112_1 and the second metal layer 112_2 may be coated with a metal material such as copper (Cu), a copper alloy, nickel (Ni), or a nickel alloy on the polymer layer 114, or may be coated with a metal material such as aluminum (Al) or an aluminum alloy. The first metal layer 112_1 and the second metal layer 112_2 may be formed of the same metal material and may function as a positive electrode or a negative electrode.

According to an embodiment, the polymer layer 114 may include a polymer material. For example, the polymer layer 114 may include polyethylene terephthalate (PET) resin. The material of the polymer layer 114 may include a polyester resin such as polytrimethylene terephthalate (PTT), polybutylene terephthalate (PBT), or polyethylene naphthalate (PEN). In this way, by using a polymer layer 114 including a polymer resin, flexibility and lightness of the first electrode 100 may be secured.

According to an embodiment, referring to FIG. 4, the thickness of each of the first metal layer 112_1 and the second metal layer 112_2 may be smaller than the thickness of the polymer layer 114. When the first metal layer 112_1 and the second metal layer 112_2 include aluminum Al, the ratio of the thickness of each of the first metal layer 112_1 and the second metal layer 112_2 to the thickness of the polymer layer 114 may be 1:8 to 1:6. When the first metal layer 112_1 and the second metal layer 112_2 include copper Cu, the ratio of the thickness of each of the first metal layer 112_1 and the second metal layer 112_2 to the thickness of the polymer layer 114 may be 2:9. However, the ratio of the thickness of each of the first metal layer 112_1 and the second metal layer 112_2 to the thickness of the polymer layer 114 may vary.

Referring to FIG. 5, a first substrate tab 140 may be welded to the surface of the metal layer 112 of the multilayer substrate 110. The first substrate tab 140 may be made of a metal foil such as copper (Cu), a copper alloy, nickel (Ni), or a nickel alloy, or may include a metal foil such as aluminum (Al) or an aluminum alloy. The material of the first substrate tab 140 may be manufactured from a metal material with excellent electrical conductivity. The first substrate tab 140 may include the same material as the first metal layer 112_1 and the second metal layer 112_2.

According to an embodiment, the first metal layer 112_1 and the second metal layer 112_2 may be coated on both sides (e.g., opposite surfaces) of the polymer layer 114. The metal layer 112 may be electrically connected to the outside by being coupled with the first substrate tab 140. Due to this, electrical conductivity and battery performance may be secured substantially the same as compared to electrodes made of a single metal material.

According to an embodiment, the first substrate tab 140 may be combined with the metal layer 112 through ultrasonic welding. The combining method may vary, and connection may be made through known combining methods such as laser welding or conductive adhesive. An embodiment in which the first substrate tab 140 is combined with the metal layer 112 through ultrasonic welding will be described below.

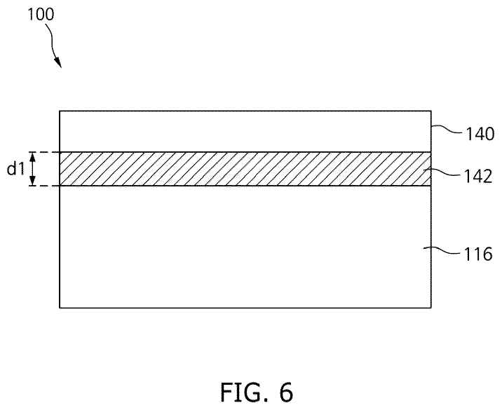

FIG. 6 is a plan view showing an example of a multilayer substrate having an active material layer disposed to be in contact with a welded portion according to an embodiment of the present disclosure. Because the first electrode 100 has a symmetrical structure along the X-X′ line, for convenience of explanation, the following description will focus on the upper part of the multilayer substrate cut along the X-X′ line of FIG. 5.

Referring to FIG. 6, the first electrode 100 may include the first substrate tab 140 including a welded portion 142 welded to the surface of the metal layer 112 (e.g., welded directly to each of the first and second metal layers 112_1 and 112_2), and an active material layer 116 disposed directly on the surface of the metal layer 112 (e.g., disposed directly on a surface of each of the first and second metal layers 112_1 and 112_2) of the multilayer substrate 110. According to an embodiment, when the first electrode 100 is formed as a positive electrode, the active material layer 116 may include a positive electrode active material.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel oxide, lithium cobalt oxide, lithium manganese oxide, lithium iron phosphate compound, cobalt-free nickel-manganese oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0≤c≤2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L1_{d}GeO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel positive electrode active material may be capable of realizing high capacity and can be applied to a high-capacity, high-density rechargeable lithium battery.

According to an embodiment, when the first electrode 100 is formed as a negative electrode, the active material layer 116 may include a negative electrode active material.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si negative electrode active material or a Sn negative electrode active material. The Si negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn negative electrode active material may include Sn, SnO2, a Sn alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si negative electrode active material or the Sn negative electrode active material may be used in combination with a carbon negative electrode active material.

According to an embodiment, the welded portion 142 may be formed by welding the overlapping surfaces of the first substrate tab 140 disposed on the metal layer 112 of the multilayer substrate 110 (e.g., the welded portion 142 may be a portion where the first substrate tab 140 and the metal layer 112 overlap each other and directly contact each other). Specifically, the welded portion 142 may be formed to extend in the longitudinal direction of the first electrode 100. The welded portion 142 may be formed with a constant width d1 of the welded portion 142 at the edge of the metal layer 112 of the multilayer substrate 110, as shown in FIG. 6.

According to an embodiment, the active material layer 116 may be disposed to be in contact with the welded portion 142 of the first substrate tab 140. The active material layer 116 may be disposed to completely cover the surface of the metal layer 112 of the multilayer substrate 110 (e.g., the active material layer 116 may completely cover the surface of the metal layer 112 that is not covered by the welded portion 142).

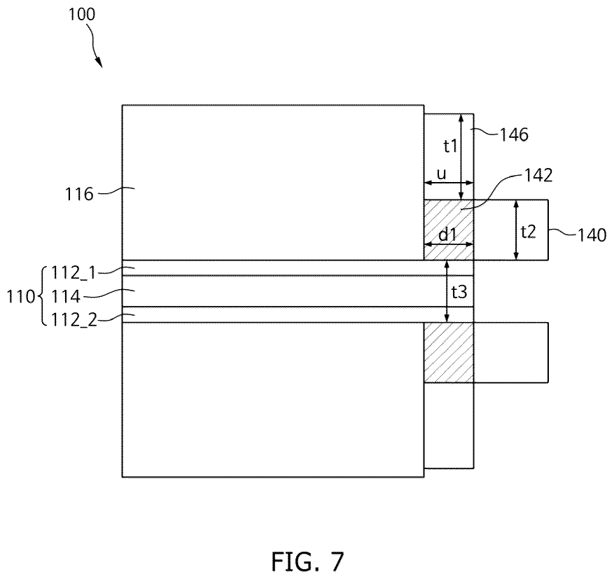

FIG. 7 is a cross-sectional view showing an example of the multilayer substrate 110 in which the active material layer and the insulating layer are disposed, according to an embodiment of the present disclosure. Description of the configurations described with reference to FIGS. 1 to 6 among the configurations shown in FIG. 7 are omitted.

Referring to FIG. 7, the insulating layer 146 may be disposed to cover at least a portion of the surface of the welded portion 142 (e.g., the welded portion 142 may separate between the insulating layer 146 and the metal layer 112). Further, the insulating layer 146 may be disposed on the welded portion 142 to be in contact (e.g., direct contact) with the active material layer 116 disposed on the metal layer 112.

According to an embodiment, the material of the insulating layer 146 may include either polyimide (PI) or ceramic. Polyimide PI is a material based on a polymer substance, and ceramics are a material based on a non-metal substance, and have high chemical stability, so they may protect the surface of a multilayer substrate 110 and prevent short circuits through excellent electrical insulation. However, the material of the insulating layer 146 may vary.

According to an embodiment, the thickness t2 of the first substrate tab 140 may be greater than or equal to the thickness t3 of the multilayer substrate 110. When the first electrode 100 is formed as a positive electrode, the ratio between the thickness t2 of the first substrate tab 140 and the thickness t3 of the multilayer substrate 110 may be 1:1 to 5:4. When the first electrode 100 is formed as a negative electrode, the ratio between the thickness t2 of the substrate tab 140 and the thickness t3 of the multilayer substrate 110 may be 1:1 to 16:13. The ratio between the thickness t2 of the first substrate tab 140 and the thickness t3 of the multilayer substrate 110 may vary.

According to an embodiment, the thickness t1 of the insulating layer 146 may be greater than the thickness t2 of the first substrate tab 140. The ratio between the thickness t1 of the insulating layer 146 and the thickness t2 of the first substrate tab 140 may be 1:1 to 3:1. The ratio between the thickness t1 of the insulating layer 146 and the thickness t2 of the first substrate tab 140 may vary, and the thickness t1 of the insulating layer 146 may be set in various ways in consideration of the electrical insulation and the solidification time of the coating layer.

According to an embodiment, the width u of the insulating layer 146 may be equal to the width d1 of the welded portion 142. The insulating layer 146 may be disposed to completely cover the surface of the welded portion 142. Due to these structural features, the insulating layer 146 is not disposed on the surface of the multilayer substrate 110 but is disposed on the surface of the welded portion 142, so that the length of the first substrate tab 140 protruding from the insulating layer 146 may be reduced by the width u of the insulating layer 146. Accordingly, the length of the first substrate tab 140 protruding from the insulating layer 146 may be reduced, so that the length of the first substrate tab 140 protruding from the separator 300 (see FIG. 1) may be reduced. Due to this, the secondary battery may be made thinner, which can improve the energy density of the secondary battery.

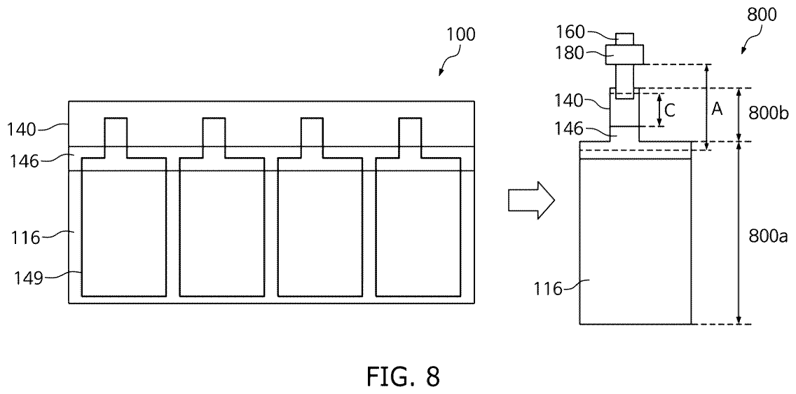

FIG. 8 is a plan view showing an example of a punched electrode according to an embodiment of the present disclosure. FIG. 8 is a drawing showing an example of the electrode of FIG. 7 being punched.

Referring to FIG. 8, the first electrode 100 may be punched into a plurality of electrodes, and the first electrode 100 may be cut along a punch line 149. According to an embodiment, the punched first electrode 800 may include a body portion 800a including an active material layer 116 and a first portion of the insulating layer 146, and a tab portion 800b protruding from the body portion 800a and including a second portion of the insulating layer 146 and the first substrate tab 140.

According to an embodiment, the punched first electrode 800 may include the first lead tab 160 connected to the first substrate tab 140 and the first insulating film 180 attached to the first lead tab 160.

According to an embodiment, the tab portion 800b may be cut to include the insulating layer 146 to prevent short circuiting. As described above, because the insulating layer 146 is disposed on the surface of the first substrate tab 140, the length of the first substrate tab 140 protruding from the insulating layer 146 at the tab portion 800b is reduced, so that the bending length A may be reduced. In some embodiments, because the length of the non-coated portion where the first substrate tab 140 is exposed is sufficient for welding the first lead tab 160, a free space equivalent to the length C between the portion where the first lead tab 160 is welded and the insulating layer 146 may be secured.

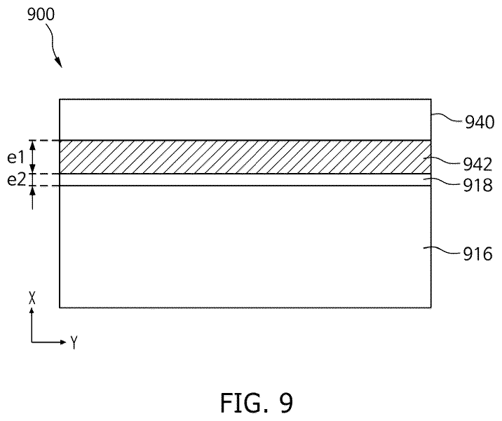

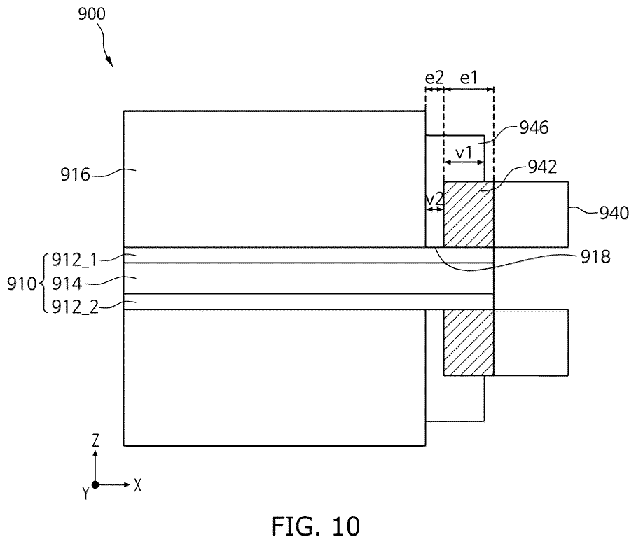

FIG. 9 is a plan view showing an example of a multilayer substrate in which the active material layer is disposed to be spaced apart from the welded portion according to an embodiment of the present disclosure, and FIG. 10 is a cross-sectional view showing an example of the multilayer substrate in which the active material layer and the insulating layer are disposed, according to an embodiment of the present disclosure.

Referring to FIGS. 9 and 10, a first electrode 900 may include a multilayer substrate 910, an active material layer 916 disposed on the surface of the multilayer substrate 910, and a non-coated portion 918 in which the surfaces of the first and second metal layers 912_1 and 912_2 of the multilayer substrate 910 are exposed.

According to an embodiment, the active material layer 916 may be disposed in the central portion (of the multilayer substrate 910) with respect to the width direction of the multilayer substrate 910. Because the active material layer 916 is not applied to at least one end in the width direction of the multilayer substrate 910, a non-coated portion 918 in which the multilayer substrate 910 is exposed may be formed (FIG. 9).

According to an embodiment, the welded portion 942 may be formed to extend in the longitudinal direction of the first electrode 900. The welded portion 942 may be formed at a location spaced apart from the boundary line between the active material layer 916 and the non-coated portion 918 by a certain distance (e.g., a portion of the non-coated portion 918 may remain between the welded portion 942 and the active material layer 916).

According to an embodiment, the insulating layer 946 may be disposed to cover at least a portion of the surface of the non-coated portion 918 and the surface of the welded portion 942 (e.g., the insulating layer 946 may continuously extend to completely cover the surface of the non-coated portion 918 and at least a portion of the surface of the welded portion 942 that faces away from the polymer layer 914). Specifically, the width v2 of the portion of the insulating layer 946 disposed on the surface of the non-coated portion 918 may be equal to the width e2 of the non-coated portion 918. Additionally, the width v1 of the portion of the insulating layer 946 disposed on the surface of the welded portion 942 may be 10% to 99% of the width e1 of the welded portion 942.

According to an embodiment, the width v1 of a portion of the insulating layer 946 disposed on the surface of the welded portion 942 may be about 90% of the width e1 of the welded portion 942. The thickness of the portion of the insulating layer 946 disposed on the surface of the non-coated portion 918 may be greater than the thickness of the portion of the insulating layer 946 disposed on the surface of the welded portion 942 (e.g., as measured along a normal direction relative to the polymer layer 914). Accordingly, the embodiment of FIG. 10 may prevent the total thickness of the first electrode 900 from increasing because the uppermost height of the insulating layer 946 is lowered compared to the embodiment of FIG. 7 (e.g., compared to combined t1 and t2 thicknesses defining the uppermost height of the insulating layer 146 in FIG. 7). Accordingly, even when the thickness of the insulating layer 946 increases, the energy density of the secondary battery may be prevented from decreasing.

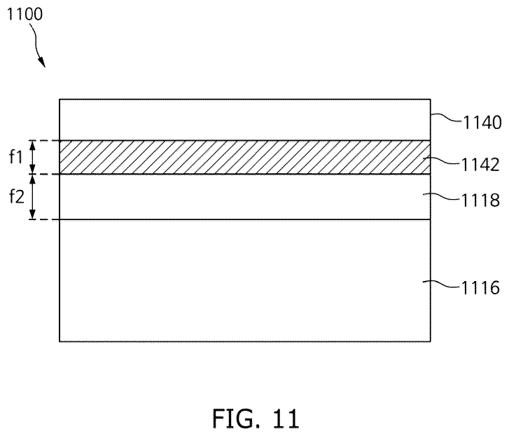

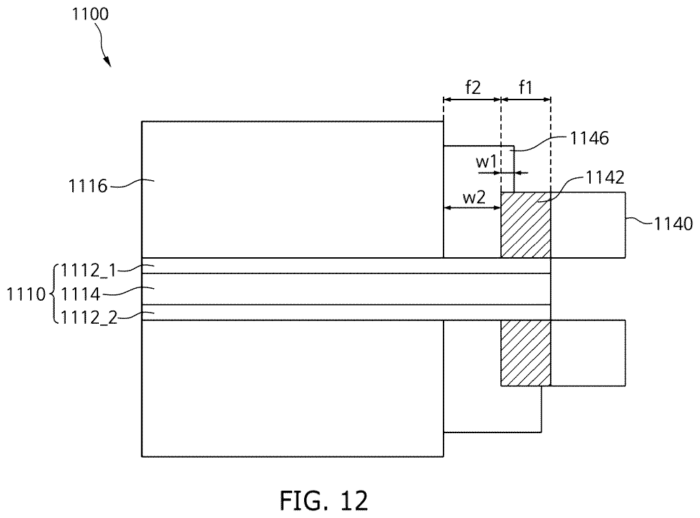

FIG. 11 is a plan view showing an example of a multilayer substrate in which the active material layer is disposed to be spaced apart from the welded portion according to an embodiment of the present disclosure, and FIG. 12 is a cross-sectional view showing an example of the multilayer substrate in which the active material layer and the insulating layer are disposed, according to an embodiment of the present disclosure.

Referring to FIGS. 11 and 12, the first electrode 1100 may include a multilayer substrate 1110, an active material layer 1116 disposed on the surface of the multilayer substrate 1110, and a non-coated portion 1118 in which the surfaces of the first and second metal layers 1112_1 and 1112_2 of the multilayer substrate 1110 are exposed.

According to an embodiment, the active material layer 1116 may be disposed in the central portion with respect to the width direction of the multilayer substrate 1110. Because the active material is not applied to at least one end in the width direction of the multilayer substrate 1110, a non-coated portion 1118 in which the multilayer substrate 1110 is exposed may be formed.

According to an embodiment, the welded portion 1142 may be formed to extend in the longitudinal direction of the first electrode 1100. The welded portion 1142 may be formed at a location spaced apart from the boundary line between the active material layer 1116 and the non-coated portion 1118 by a certain distance.

According to an embodiment, the insulating layer 1146 may be disposed to cover at least a portion of the surface of a non-coated portion 1118 and the surface of a welded portion 1142. Specifically, the width w2 of the portion of the insulating layer 1146 disposed on the surface of the non-coated portion 1118 may be equal to the width f2 of the non-coated portion 1118. Additionally, the width w1 of the portion of the insulating layer 1146 disposed on the surface of the welded portion 1142 may be about 10% of the width f1 of the welded portion 1142.

According to an embodiment, the thickness of a portion of the insulating layer 1146 disposed on the surface of the non-coated portion 1118 may be greater than the thickness of a portion of the insulating layer 1146 disposed on the surface of the welded portion 1142. Accordingly, the embodiment of FIG. 12 may prevent the total thickness of the first electrode 1100 from increasing because the uppermost height of the insulating layer 1146 is lowered compared to the embodiment of FIG. 7. Accordingly, even when the thickness of the insulating layer 1146 increases, the energy density of the secondary battery may be prevented from decreasing.

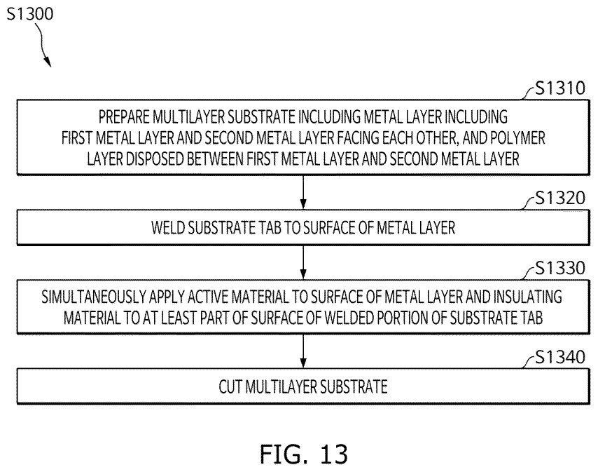

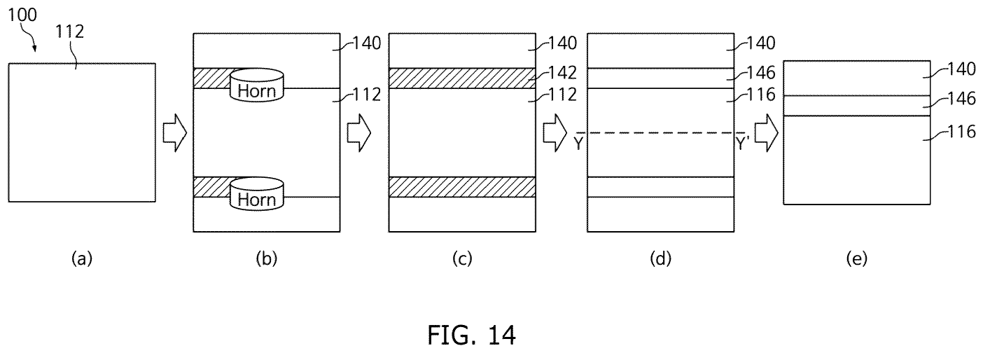

FIG. 13 is a flow chart of a method for manufacturing an electrode according to an embodiment of the present disclosure, and FIG. 14 is a diagram of stages in a method for manufacturing an electrode according to an embodiment of the present disclosure.

Referring to FIG. 13 and FIG. 14, an electrode manufacturing method (S1300) may be initiated by preparing a multilayer substrate 110 including a metal layer 112 including a first metal layer and a second metal layer facing each other, and a polymer layer disposed between the first metal layer and the second metal layer (S1310). The metal layer 112 is illustrated in part (a) of FIG. 14.

In an embodiment, each of the first metal layer and the second metal layer may be coated with a metal material such as copper (Cu), a copper alloy, nickel (Ni), or a nickel alloy on the polymer layer, or may be coated with a metal material such as aluminum (Al) or an aluminum alloy. The first metal layer and the second metal layer may be formed of the same metal material and may function as a positive electrode or a negative electrode. In an embodiment, the polymer layer may include a polymer material. For example, the polymer layer 114 may include polyethylene terephthalate (PET) resin. The material of the polymer layer 114 may vary, and may include a polyester resin such as polytrimethylene terephthalate (PTT), polybutylene terephthalate (PBT), or polyethylene naphthalate (PEN).

As shown in part (a) of FIG. 14, the multilayer substrate 110 may be prepared such that the metal layer 112 faces the outside.

Next, as shown in parts (b) and (c) of FIG. 14, the substrate tab 140 may be welded to the surface of the metal layer 112 (S1320). In an embodiment, welding the substrate tab 140 to the surface of the metal layer 112 may include ultrasonically welding one end of the metal layer 112 such that the substrate tab 140 protrudes from the metal layer 112. In an embodiment, the metal layer 112 and the substrate tab 140 may be ultrasonically welded using a welding horn. In an embodiment, the welding horn may include a welding head having an approximately disc-shaped welding head, and the welding head may have a pressure surface formed along an outer periphery of the disc.

The following Table 1 shows experimental result data including the results of measuring the welding deviation between the metal layer 112 and the substrate tab 140 for each of types (A, B) of welding horn. Additionally, Table 1 is obtained by measuring the welding deviation four times for each of types (A, B) of welding horn to derive the welding deviation. That is, regarding the welding deviation in Table 1, the welding deviation is measured multiple times for each type of welding horn, thereby reducing the occurrence of errors that may occur when measuring the result data.

TABLE 1

| | Horn | | | | | | | |
|---|---|---|---|---|---|---|---|---|
| | A | | | | B | | | |
| | 1 | 2 | 3 | 4 | 1 | 2 | 3 | 4 |
| Deviation (±) | 0.13 | 0.12 | 0.15 | 0.14 | 0.10 | 0.08 | 0.12 | 0.10 |
| (mm) | | | | | | | | |

Welding quality may be improved by welding a substrate tab 140 to the surface of the multilayer substrate 110 before applying an active material and an insulating material to the surface of the multilayer substrate 110. Specifically, in Table 1, the welding deviation is within ±0.15 mm regardless of the types (A, B) of welding horn, so that the welding between the metal layer 112 and the substrate tab 140 may secure excellent quality. This may improve the problem of electrode sagging in subsequent processes such as a pressing process and a slitting process after coating.

The following Table 2 shows experimental result data including the results of measuring the welding strength between the metal layer 112 and the substrate tab 140. Additionally, Table 2 shows that the welding strength is measured six times using a 2.5 mm welding horn to calculate the welding strength. That is, in Table 2, the welding strength is measured multiple times, thereby reducing the occurrence of errors that may occur when measuring the result data.

TABLE 2

| Horn (2.5 mm) | 1 | 2 | 3 | 4 | 5 | 6 |
|---|---|---|---|---|---|---|
| Welding | 1.521 | 2.127 | 1.391 | 1.506 | 1.253 | 1.345 |
| strength (kgf) | | | | | | |

Welding quality may be improved by welding a substrate tab 140 to the surface of the multilayer substrate 110 before applying an active material and an insulating material to the surface of the multilayer substrate 110. Specifically, the welding strength is 1.2 kgf or more by using a welding horn of 2.5 mm in Table 2, so that the welding between the metal layer 112 and the substrate tab 140 may secure excellent quality. This may improve the problem of electrode sagging in subsequent processes such as a pressing process and a slitting process after coating.

Thereafter, as shown in part (d) of FIG. 14, an active material may be applied to the surface of the metal layer 112 and an insulating material may be applied to at least a part of the surface of the welded portion 142 of the substrate tab 140, simultaneously (S1330).

In an embodiment, the step S1330 of simultaneously applying an active material to the surface of the metal layer 112 and an insulating material to at least a part of the surface of the welded portion 142 of the substrate tab 140 may include a step of applying the active material to be in contact with the welded portion 142 and completely cover the surface of the metal layer 112, and a step of applying the insulating material to be in contact with the active material and completely cover the surface of the welded portion 142.

Finally, as shown in part (e) of FIG. 14, the multilayer substrate 110 may be cut (S1340). In an embodiment, cutting the multilayer substrate 110 may include cutting the multilayer substrate parallel to the length direction of the multilayer substrate. Specifically, the multilayer substrate 110 may be cut along the Y-Y′ line illustrated in FIG. 14.

The flow charts of FIGS. 13 and 14 and the above description are only examples of the present disclosure, and the scope of the present disclosure may vary. For example, one or more steps in the flowchart and/or the descriptions above may be added, changed, or deleted, the order of one or more steps may be changed, and one or more steps may be performed simultaneously.

By way of summation and review, a multilayer substrate may be used in secondary batteries of various shapes, such as cylindrical, square, and pouch shapes. In some forms of secondary batteries, thinning of the secondary battery may be required to improve energy density. However, because separate substrate tabs are welded to the multilayer substrate, the lengths of the electrode terminals of the electrode assembly and the substrate tabs protruding from the electrode assembly may be increased. As such, it may be difficult to thin some types of secondary batteries.

In contrast, according to some embodiments of the present disclosure, an electrode in which energy density of a secondary battery can be improved, an electrode assembly including the same, and a method for manufacturing the electrode may be provided.

According to some embodiments of the present disclosure, an electrode in which energy density of a secondary battery can be improved by reducing the length of a substrate tab protruding from an electrode assembly to make the secondary battery thinner, an electrode assembly including the same, and a method for manufacturing the electrode may be provided.

According to some embodiments of the present disclosure, by arranging an insulating layer on a multilayer substrate and/or substrate tab, the possibility of a physical short circuit between the positive and negative electrodes due to deformation of the secondary battery or shrinkage of the separator in a high-temperature atmosphere may be reduced.

According to some embodiments of the present disclosure, by welding a substrate tab to the surface of a multilayer substrate before applying an active material and an insulating material to the surface of the multilayer substrate, the welding quality between the multilayer substrate and the substrate tab may be improved, so that the problem of the electrode sagging in subsequent processes such as a pressing process and a slitting process may be improved.

However, aspects and features of the present disclosure are not limited to those described above, and other aspects and features not mentioned will be clearly understood by a person skilled in the art from the detailed description, described above.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An electrode, comprising:
a multilayer substrate including a polymer layer between a first metal layer and a second metal layer;
a substrate tab including a welded portion, the welded portion being welded to a surface of at least one of the first metal layer and the second metal layer;
an active material layer on the surface of at least one of the first metal layer and the second metal layer, the active material layer including an active material; and
an insulating layer covering at least a portion of the welded portion.

2. The electrode as claimed in claim 1, wherein the polymer layer includes polyethylene terephthalate.

3. The electrode as claimed in claim 1, wherein each of the first metal layer and the second metal layer includes aluminum or copper.

4. The electrode as claimed in claim 1, wherein a thickness of each of the first metal layer and the second metal layer is smaller than a thickness of the polymer layer.

5. The electrode as claimed in claim 1, wherein the substrate tab includes aluminum or copper.

6. The electrode as claimed in claim 1, wherein the insulating layer includes polyimide or ceramic.

7. The electrode as claimed in claim 1, wherein the active material layer is in contact with each of the welded portion and the insulating layer.

8. The electrode as claimed in claim 7, wherein a thickness of the insulating layer is greater than a thickness of the substrate tab.

9. The electrode as claimed in claim 7, wherein a width of the insulating layer is equal to a width of the welded portion.

10. The electrode as claimed in claim 1, wherein:
the multilayer substrate includes a non-coated portion where a surface of at least one of the first metal layer and the second metal layer is exposed,
the welded portion is spaced apart from a boundary line between the active material layer and the non-coated portion by a certain distance, and
the insulating layer covers at least a portion of the non-coated portion and the welded portion.

11. The electrode as claimed in claim 10, wherein:
a width of a first portion of the insulating layer on the non-coated portion is a same as a width of the non-coated portion, and
a width of a second portion of the insulating layer on the welded portion is 10% to 99% of the width of the welded portion.

12. The electrode as claimed in claim 10, wherein a thickness of a first portion of the insulating layer on the non-coated portion is greater than a thickness of a second portion of the insulating layer on the welded portion.

13. An electrode assembly, comprising:
a first electrode including:
a multilayer substrate including a polymer layer between a first metal layer and a second metal layer,
a first substrate tab connected to a first lead tab, the first substrate tab including a welded portion welded to a surface of at least one of the first metal layer and the second metal layer,
an active material layer on the surface of the at least one of the first metal layer and the second metal layer, the active material layer including an active material, and
an insulating layer covering at least a portion of the welded portion;
a second electrode including a second substrate tab connected to a second lead tab; and
a separator between the first electrode and the second electrode.

14. The electrode assembly as claimed in claim 13, wherein:
the active material layer is in contact with the welded portion, and
the insulating layer is in contact with the active material layer.

15. The electrode assembly as claimed in claim 14, wherein a width of the insulating layer is equal to a width of the welded portion.

16. The electrode assembly as claimed in claim 13, wherein the first substrate tab and the second substrate tab protrude from the separator.

17. A method for manufacturing an electrode, the method comprising:
preparing a multilayer substrate including a polymer layer between a first metal layer and a second metal layer;
welding a substrate tab to a surface of at least one of the first metal layer and the second metal layer to form a welded portion;
simultaneously applying an active material to the surface of the at least one of the first metal layer and the second metal layer and an insulating material to at least a portion of the welded portion; and
cutting the multilayer substrate.

18. The method as claimed in claim 17, wherein welding the substrate tab includes ultrasonically welding one end of the at least one of the first metal layer and the second metal layer such that the substrate tab protrudes from the at least one of the first metal layer and the second metal layer.

19. The method as claimed in claim 17, wherein simultaneously applying the active material and the insulating material includes:
applying the active material to be in contact with the welded portion and completely cover the surface of the at least one of the first metal layer and the second metal layer, and
applying the insulating material to be in contact with the active material and completely cover the welded portion.

20. The method as claimed in claim 17, wherein cutting the multilayer substrate includes cutting the multilayer substrate parallel to a length direction of the multilayer substrate.
